(19) United States
(12) Patent Application Publication
(10) Pub. No.: US 2021/0004007 A1
(43) Pub. Date: Jan. 7, 2021

(54) CONTROL DEVICE OF PROPELLER FOR SHIP, CONTROL METHOD OF PROPELLER FOR SHIP, AND CONTROL PROGRAM OF PROPELLER FOR SHIP

(71) Applicant: HONDA MOTOR CO., LTD., Tokyo (JP)

(72) Inventors: Akifumi FUJIMA, Wako-shi, Saitama (JP); Takashi HASHIZUME, Wako-shi, Saitama (JP); Hiroshi YAMAMOTO, Wako-shi, Saitama (JP)

(21) Appl. No.: 16/982,792

(22) PCT Filed: Mar. 23, 2018
(86) PCT No.: PCT/JP2018/011732

§ 371 Date: Sep. 21, 2020

(51) Int. Cl. G05D 1/02; B63H 20/12; B63B 79/15; B63B 79/40

(52) U.S. Cl. CPC G05D 1/0206; B63H 20/12; B63H 2020/003; B63B 79/40; B63B 79/15

(57) ABSTRACT

A control device, a control method, and a control program of a propeller for ship that enable the ship to move accurately in parallel are provided. When a joystick is tilted in a predetermined direction, a system controller performs a second control to make a ship move in parallel in accordance with corrected control parameters while correcting control parameters of outboard motors for moving the ship in the predetermined direction, on condition that wave height at a current position of the ship is equal to or higher than a threshold value, determines whether the control parameters are appropriate from a moving state of the ship when the ship is moved in accordance with the control parameters, on the condition that the wave height is lower than the threshold value, and rewrites the control parameters so that the ship moves in parallel when the control parameters are not appropriate.

### TECHNICAL FIELD

The present invention relates to a control device of a propeller for a ship, a control method of a propeller for a ship, and a control program of a propeller for a ship.

### BACKGROUND ART

There has been suggested a ship that can make movement (hereinafter, referred to as parallel movement) laterally or diagonally without turning the ship by controlling an output and a steering angle of a pair of outboard motors provided at a stern according to an operation of an operating device on a joystick, and the like (for example, refer to Patent Document 1).

### CITATION LIST

### Patent Literature

[Patent Document 1] Japanese Unexamined Patent Publication No. 2010-126085

### SUMMARY OF INVENTION

### Technical Problem

In the ship described in Patent Document 1, when the joystick is tilted in a predetermined direction, it is necessary that the operation state of the joystick and the control contents of the pair of outboard motors are associated with each other such that the ship can make parallel movement in a direction corresponding to the predetermined direction.

However, since there are various combinations of the joystick and the outboard motor, there is a case where the predetermined control contents are not appropriate depending on the combination.

Here, in the ship, it is determined whether or not the ship is making parallel movement, and in a case where the ship is not making the parallel movement, it is considered to perform update processing of updating the above-described control contents to appropriate contents. However, the posture of the ship is unlikely to be stabilized on the days with strong winds or rough waves. Therefore, it is necessary to distinguish between a state where the ship is not making parallel movement due to wind or waves, and a state where the ship is not making parallel movement because the predetermined control contents are not appropriate.

When the control contents are updated such that the ship can make parallel movement in a state where the ship is turning due to winds or waves, the control contents become not appropriate on the days without winds or waves, and there is a possibility that the update processing is repeatedly performed.

The present invention has been made in view of the above-described circumstances, and an object thereof is to provide a control device of a propeller for a ship, a control method of a propeller for a ship, and a control program of a propeller for a ship that enable the ship to make accurate parallel movement.

### Solution to Problem

According to an aspect of the present invention, there is provided a control device of a propeller for a ship that controls the propeller in the ship equipped with a plurality of propellers, the device including: a storage that stores a set of control parameters for each of the plurality of propellers in association with an operation signal input from an operation unit to make the ship move in parallel; a controller that selectively performs a first control for controlling the plurality of propellers by the set corresponding to a first operation signal in a case where the first operation signal to make the ship move in parallel in a predetermined direction is input, and a second control for starting the control of the plurality of propellers by the set corresponding to the first operation signal, and controlling the plurality of propellers by the corrected set while correcting the set so that the ship makes parallel movement based on the moving state of the ship after the control; an update processing unit that performs update processing of rewriting the set corresponding to the first operation signal stored in the storage, based on the moving state of the ship that moves according to the first control; a weather information acquisition unit that acquires weather information of the sea where the ship exists; and a first determination unit that determines whether or not the situation is suitable for the update processing based on the weather information, in which the controller performs the first control in a case where the first determination unit determines that the situation is suitable for the update processing, and performs the second control in a case where the first determination unit determines that the situation is not suitable for the update processing, in which the control device further comprises a second determination unit that determines whether or not the set corresponding to the first operation signal is appropriate, based on the moving state of the ship that moves according to the first control performed by the controller, in a case where the first determination unit determines that the situation is suitable for the update processing, and in which the update processing unit performs the update processing in a case where the second determination unit determines that the set is not appropriate.

According to another aspect of the present invention, there is provided a control method of a propeller for a ship for controlling the propeller in the ship equipped with an operation unit that makes the ship having a plurality of propellers make parallel movement, a storage that stores a set of control parameters for each of the plurality of propellers in association with an operation signal input from the operation unit, and the plurality of propellers, the method including: a control step of selectively performing a first control for controlling the plurality of propellers by the set corresponding to a first operation signal in a case where the first operation signal to make the ship move in parallel in a predetermined direction is input, and a second control for starting the control of the plurality of propellers by the set corresponding to the first operation signal, and controlling the plurality of propellers by the corrected set while correcting the set so that the ship makes parallel movement based on the moving state of the ship after the control; an update processing step of performing update processing of rewriting the set corresponding to the first operation signal stored in the storage, based on the moving state of the ship that moves according to the first control; a weather information acquisition step of acquiring weather information of the sea where the ship exists; and a first determination step of determining whether or not the situation is suitable for the update processing based on the weather information, in which, in the control step, the first control is performed in a case where it is determined that the situation is suitable for the update processing in the first determination step, and the second control is performed in a case where it is determined that the situation is not suitable for the update processing in the first determination step, in which the control method further comprises a second determination step of determining whether or not the set corresponding to the first operation signal is appropriate, based on the moving state of the ship that moves according to the first control performed in the control step, in a case where it is determined that the situation is suitable for the update processing in the first determination step, and in which, in the update processing step, the update processing is performed in a case where it is determined that the set is not appropriate in the second determination step.

According to still another aspect of the present invention, there is provided a control program of a propeller for a ship for causing a computer to execute a control method of a propeller for a ship for controlling the propeller in the ship equipped with an operation unit that makes the ship having a plurality of propellers make parallel movement, a storage that stores a set of control parameters for each of the plurality of propellers in association with an operation signal input from the operation unit, and the plurality of propellers, the method including: a control step of selectively performing a first control for controlling the plurality of propellers by the set corresponding to a first operation signal in a case where the first operation signal to make the ship move in parallel in a predetermined direction is input, and a second control for starting the control of the plurality of propellers by the set corresponding to the first operation signal, and controlling the plurality of propellers by the corrected set while correcting the set so that the ship makes parallel movement based on the moving state of the ship after the control; an update processing step of performing update processing of rewriting the set corresponding to the first operation signal stored in the storage, based on the moving state of the ship that moves according to the first control; a weather information acquisition step of acquiring weather information of the sea where the ship exists; and a first determination step of determining whether or not the situation is suitable for the update processing based on the weather information, in which, in the control step, the first control is performed in a case where it is determined that the situation is suitable for the update processing in the first determination step, and the second control is performed in a case where it is determined that the situation is not suitable for the update processing in the first determination step, in which the control method further comprises a second determination step of determining whether or not the set corresponding to the first operation signal is appropriate, based on the moving state of the ship that moves according to the first control performed in the control step, in a case where it is determined that the situation is suitable for the update processing in the first determination step, and in which, in the update processing step, the update processing is performed in a case where it is determined that the set is not appropriate in the second determination step.

### Advantageous Effects of Invention

According to the present invention, it is possible to provide a control device of a propeller for a ship, a control method of a propeller for a ship, and a control program of a propeller for a ship that enable the ship to accurately make parallel movement.

### BRIEF DESCRIPTION OF DRAWINGS

FIG. 1 is a schematic view illustrating an external configuration of a ship including a system controller which is an embodiment of a control device of the present invention.

FIG. 2 is a block diagram illustrating a main configuration of hardware of the ship illustrated in FIG. 1.

FIG. 3 is a view illustrating functional blocks of the system controller illustrated in FIG. 2.

FIG. 4 is a flowchart for describing an operation of the system controller in a case where a joystick is tilted in a predetermined direction.

FIG. 5 is a flowchart for describing a first modification example of the operation of the system controller in a case where the joystick is tilted in the predetermined direction.

FIG. 6 is a flowchart for describing a second modification example of the operation of the system controller in a case where the joystick is tilted in a predetermined direction.

### DESCRIPTION OF EMBODIMENTS

Hereinafter, embodiments of the present invention will be described with reference to the drawings.

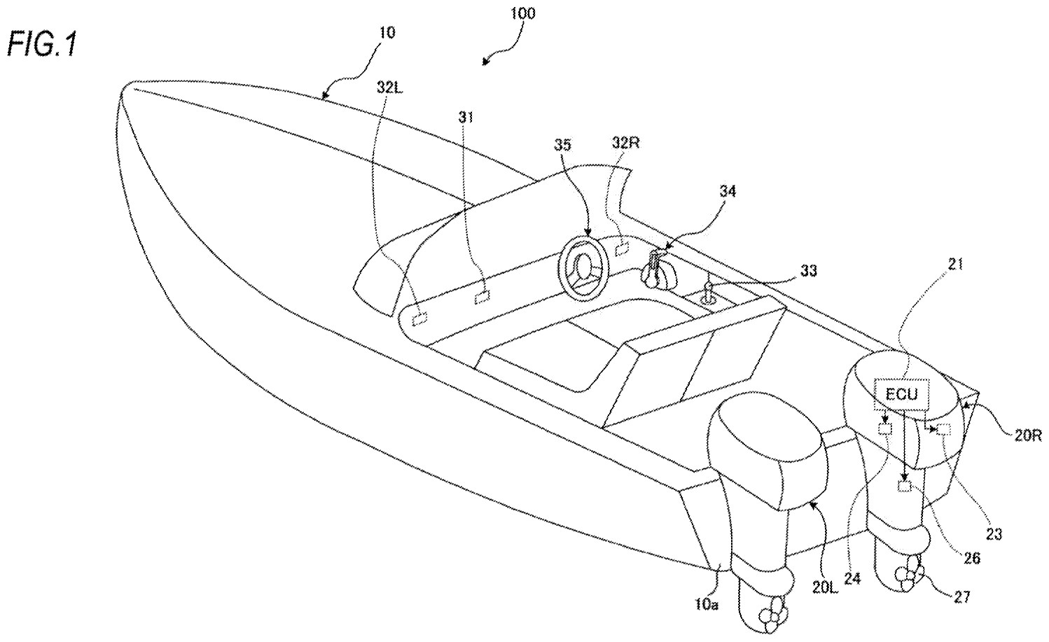

FIG. 1 is a schematic view illustrating an external configuration of a ship 100 including a system controller which is an embodiment of a control device of the present invention.

The ship 100 includes a hull 10, an outboard motor 20R and an outboard motor 20L that are mounted on a stern 10a of the hull 10 and that configure a propeller with a variable steering angle, an orientation sensor 31 provided on the hull 10, a receiver 32R provided on the right side of the hull 10, a receiver 32L provided on the left side of the hull 10, a joystick 33 that configures an operation unit provided on the hull 10, a shift/throttle operating device 34 provided on the hull 10, and a steering device 35 provided on the hull 10.

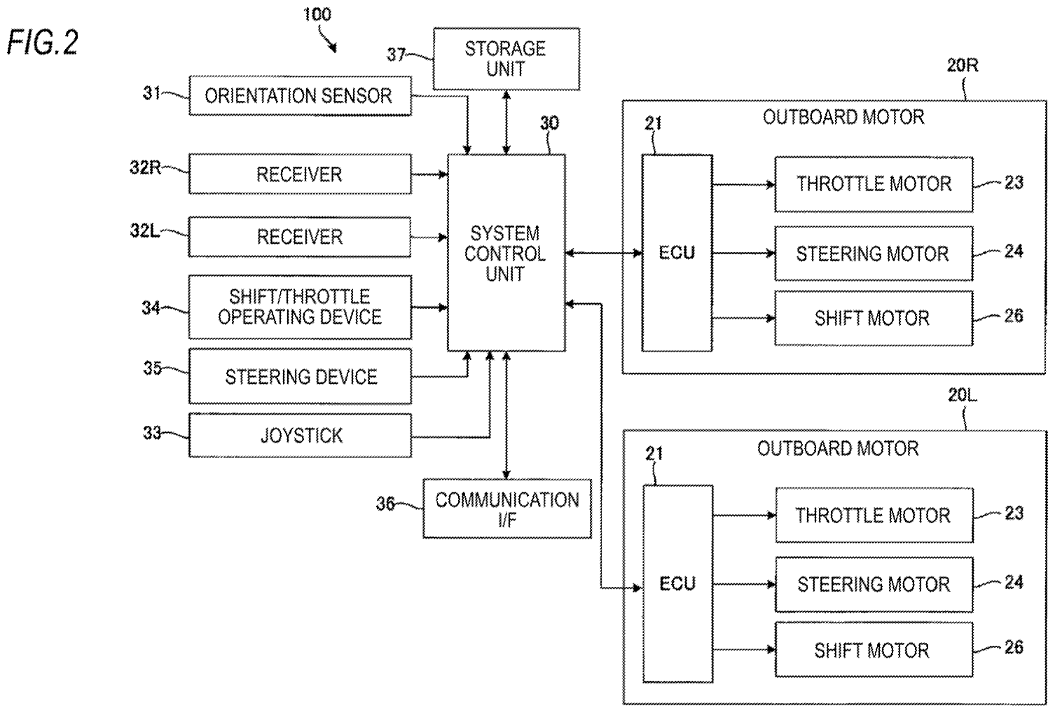

The orientation sensor 31 detects the orientation of the stem of the hull 10 and sends information on the detected orientation to a system controller 30 (refer to FIG. 2) which will be described later.

The receiver 32R and the receiver 32L are receivers for global navigation satellite system (GNSS), such as global positioning system (GPS), respectively, receive, for example, a signal from a GPS satellite, and send the received signal to the system controller 30 (refer to FIG. 2) which will be described later.

The receiver 32R and the receiver 32L are disposed side by side in a direction orthogonal to the direction in which the stem and the stern 10a of the hull 10 are connected to each other.

Since the outboard motor 20R and the outboard motor 20L have the same configuration, only the outboard motor 20R will be described below. The outboard motor 20R includes an electronic control unit (ECU) 21, an internal combustion engine (not illustrated), a propeller 27 that is rotated by power from the internal combustion engine, a throttle motor 23, a steering motor 24, and a shift motor 26.

The ECU 21 includes various processors that execute programs to perform processing, a random access memory (RAM), and a read only memory (ROM).

As the above-described various processors, a central processing unit (CPU) which is a general processor that executes a program to perform various types of processing, a programmable logic device (PLD) which is a processor of which a circuit configuration can be changed after manufacturing, such as a field programmable gate array (FPGA), a dedicated electric circuit which is a processor having a circuit configuration designed to be dedicated for executing specific processing, such as an application specific integrated circuit (ASIC), and the like, are included.

More specifically, the structures of these various processors are electric circuits in which circuit elements such as semiconductor elements are combined.

The throttle motor 23 is an actuator for opening and closing the throttle valve of the internal combustion engine.

The steering motor 24 is an actuator for driving a steering mechanism that rotates the outboard motor 20R around the vertical shaft and changes the direction of the outboard motor 20R with respect to the direction in which the stem and the stern 10a of the hull 10 are connected to each other.

The shift motor 26 is an actuator for driving a shift mechanism that switches the rotational direction of the propeller 27 between forward and reverse.

The joystick 33 is a device for performing an operation of making the ship 100 move in parallel. When the joystick 33 is tilted in the predetermined direction, an operation signal for making the ship 100 move in parallel in the predetermined direction is input to the system controller 30 which will be described later.

The shift/throttle operating device 34 is a device for performing shift changes and propelling force adjustment of the outboard motor 20R and the outboard motor 20L.

The steering device 35 is a device for performing the steering operation of the outboard motor 20R and the outboard motor 20L.

FIG. 2 is a block diagram illustrating a main configuration of hardware of the ship 100 illustrated in FIG. 1.

The ship 100 includes the system controller 30, a communication interface (I/F) 36, and a storage 37, in addition to the orientation sensor 31, the receiver 32R, the receiver 32L, the joystick 33, the shift/throttle operating device 34, the steering device 35, the outboard motor 20R, and the outboard motor 20L. The system controller 30 and the storage 37 configure a control device of a propeller for a ship.

The system controller 30 is the above-described various processors that execute a program including a control program to perform the processing.

The system controller 30 and each part of the orientation sensor 31, the receiver 32R, the receiver 32L, the joystick 33, the shift/throttle operating device 34, the steering device 35, the ECU 21 of the outboard motor 20R, and the ECU 21 of the outboard motor 20L configure to be capable of communicating with each other by wire communication or wireless communication.

The system controller 30 and each part are connected to each other by, for example, communication method (for example, NMEA 2000, specifically, controller area network (CAN)) standardized by National Marine Electronics Association (NMEA).

The storage 37 includes a ROM that stores a program including a control program, and a RAM. In the ROM of the storage 37, a set of control parameters (control contents) of each of the outboard motor 20R and the outboard motor 20L is stored in advance in association with each of a plurality of operation signals that can be input from the joystick 33.

The control parameters are information that respectively specify the opening of the throttle valve, the steering angle of the steering mechanism, and the rotational direction of the propeller 27.

The set stored in the ROM of the storage 37 is data created when the joystick 33 was manufactured. Therefore, depending on the combination of the joystick 33 and the outboard motor 20R and the outboard motor 20L, there is a case where the ship 100 does not move in parallel even in a case where the outboard motor 20R and the outboard motor 20L are controlled according to this set. Therefore, there is a case where it is necessary to update (rewrite) this set as will be described later.

The communication I/F 36 is an interface for connecting to a network such as the Internet via a mobile phone network or the like.

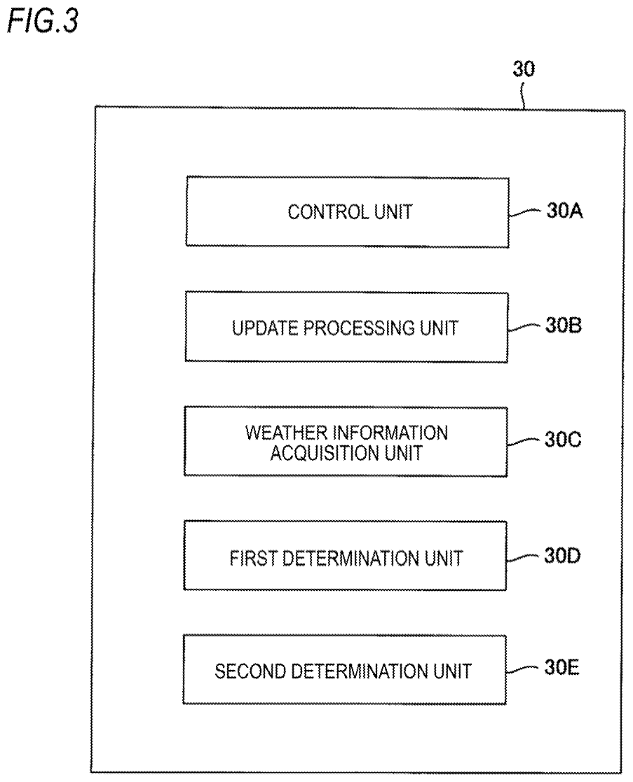

FIG. 3 is a view illustrating functional blocks of the system controller 30 illustrated in FIG. 2.

The system controller 30 executes a program including the control program stored in the storage 37 and cooperates with various hardware of the ship 100 to function as a controller 30A, an update processing unit 30B, a weather information acquisition unit 30C, a first determination unit 30D, and a second determination unit 30E.

The controller 30A selectively performs any of a first control and a second control in a case where a first operation signal to make the ship 100 move in parallel in the predetermined direction is input from the joystick 33.

The first control means the control of the outboard motor 20R and the outboard motor 20L by the set corresponding to the first operation signal of the plurality of sets stored in the storage 37.

The second control means that the start of the control of the outboard motor 20R and the outboard motor 20L by the set corresponding to the first operation signal of the plurality of sets stored in the storage 37, and the control of the outboard motor 20R and the outboard motor 20L by the corrected set while correcting the set such that the ship 100 makes parallel movement in the predetermined direction based on the moving state of the ship 100 after the control.

In this second control, the set corresponding to the first operation signal stored in the storage 37 is not rewritten, and this set is corrected in real time on the RAM of the storage 37 and used.

The update processing unit 30B performs update processing of rewriting the set corresponding to the first operation signal stored in the storage 37 based on the moving state of the ship 100 that moves under the first control.

Specifically, the update processing unit 30B periodically detects the orientation of the ship 100 that moves under the first control based on the information of the orientation sensor 31, and changes the control parameters of the outboard motors 20R and 20L such that the detected orientation is the same as the orientation of the ship 100 when the first operation signal is input. Then, this changed control parameters are overwritten on the set corresponding to the first operation signal to update this set.

By performing this update processing, in a case where the outboard motor 20R and the outboard motor 20L are controlled by the set of the storage 37, when the waves are in a stable state, the ship 100 can move in parallel.

The weather information acquisition unit 30C acquires the weather information of the sea in which the ship 100 exists. The weather information is information on wave height or information on wind strength (wind speed) over the sea. The weather information acquisition unit 30C accesses the Internet via the communication I/F 36 and acquires weather information from a server that provides weather information.

In addition, the ship 100 may be provided with an anemometer, and the weather information acquisition unit 30C may acquire the information on wind strength from the information of the anemometer.

The first determination unit 30D determines whether or not the situation is suitable for the update processing performed by the update processing unit 30B based on the weather information acquired by the weather information acquisition unit 30C.

It is necessary to perform the update processing in a state where the waves are stable. This is because, when the update processing is performed in a state where the waves are not stable, in a case where the outboard motor 20R and the outboard motor 20R are controlled according to the updated set in a state where the waves are stable, the ship 100 cannot move in parallel. Therefore, the situation in which the waves are stable is suitable for the update processing. Whether or not the waves are stable can be determined by information on wave height or information on wind strength.

In a case where the first determination unit 30D determines that the situation is suitable for the update processing, the second determination unit 30E determines whether or not the set corresponding to the first operation signal is appropriate based on the moving state of the ship 100 that moves under the first control performed in accordance with the first operation signal.

For example, the second determination unit 30E periodically detects the orientation of the ship 100 based on the information from the orientation sensor 31 when the first control is started by the set corresponding to the first operation signal. When the set corresponding to the first operation signal is appropriate, this orientation becomes substantially constant. However, when the set corresponding to the first operation signal is not appropriate, this orientation changes by a constant amount in a constant direction.

Therefore, the second determination unit 30E determines that the set corresponding to the first operation signal is appropriate in a case where the orientation of the ship 100 during the first control changes in a constant direction and the amount of change in the orientation is substantially the same. In addition, the second determination unit 30E determines that the set corresponding to the first operation signal is appropriate in a case where there is almost no change in orientation of the ship 100 during the first control.

Otherwise, when the first control is started by the set corresponding to the first operation signal, the second determination unit 30E periodically acquires the position coordinates (hereinafter, referred to as right coordinates) of the right side of the ship 100 detected by the receiver 32R, and the position coordinates (hereinafter, referred to as left coordinates) of the left side of the ship 100 detected by the receiver 32L.

The right coordinates and the left coordinates acquired at a certain timing T1 are R(x1, y1) and L(x1, y1), respectively. Further, the right coordinates and the left coordinates acquired at a timing T2 subsequent to the timing T1 are defined as R(x2, y2) and L(x2, y2), respectively.

In this case, when a movement amount mx by which the ship 100 moves in the x direction and a movement amount my by which the ship 100 moves in the y direction between the timing T1 and the timing T2 are values determined by the contents of the set corresponding to the first operation signal. Therefore, when the set is appropriate, the following relational equations are established.

R(x2,y2)=R(x1+xm,y1+ym) Equation (a)

L(x2,y2)=L(x1+xm,y1+ym) Equation (b)

The second determination unit 30E can determine that the set is appropriate in a case of satisfying all of a first condition that the difference between the x coordinate of R(x2, y2) and the x coordinate of R(x1, y1) is within a range of the movement amount mx±α (α is, for example, several % of the movement amount mx), a second condition that the difference between the y coordinate of R(x2, y2) and the y coordinate of R(x1, y1) is within a range of the movement amount my±β (β is, for example, several % of the movement amount my), a third condition that the difference between the x coordinate of L(x2, y2) and the x coordinate of L(x1, y1) is within a range of the movement amount mx±α, and a fourth condition that the difference between the y coordinate of L(x2, y2) and the y coordinate of L(x1, y1) is within a range of the movement amount my±β.

The second determination unit 30E can determine that the set is not appropriate in a case where at least one of the first condition, the second condition, the third condition, and the fourth condition is not satisfied.

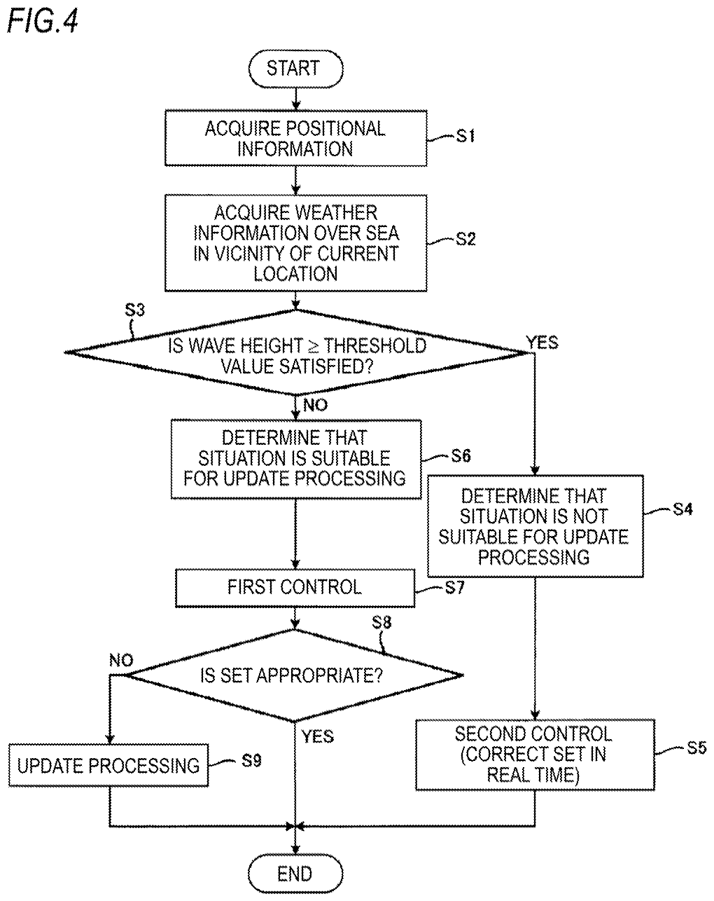

FIG. 4 is a flowchart for describing an operation of the system controller 30 illustrated in FIG. 2 in a case where the joystick 33 is tilted in the predetermined direction.

First, the weather information acquisition unit 30C of the system controller 30 acquires positional information of the ship 100 based on the information from the receiver 32R or the receiver 32L (step S1). Then, the weather information acquisition unit 30C of the system controller 30 uses this positional information to acquire the weather information of the sea at the current position of the ship 100 (step S2). Here, as the weather information, description will be made on the assumption that the information on wave height is acquired.

When the information on wave height is acquired, the first determination unit 30D of the system controller 30 determines whether or not the wave height is equal to or higher than a predetermined threshold value (step S3). In a case where the information on wind strength is acquired as the weather information in step S2, in step S3, the first determination unit 30D of the system controller 30 may determine whether or not the wind strength is equal to or greater than the predetermined threshold value.

The first determination unit 30D of the system controller 30 determines that the situation is not suitable for the update processing in a case where the determination in step S3 is YES (in a case where the wave height is equal to or higher than the threshold value) (step S4). After step S4, the second control is started by the controller 30A of the system controller 30 (step S5).

First, the controller 30A of the system controller 30 starts controlling the outboard motor 20R and the outboard motor 20L by the set corresponding to the operation signal input from the joystick 33. Then, the controller 30A of the system controller 30, for example, periodically detects the orientation of the ship 100 from the information of the orientation sensor 31, corrects this set such that the detected orientation matches the orientation when the operation signal is input, and controls the outboard motor 20R and the outboard motor 20L according to the corrected set.

In addition, the controller 30A of the system controller 30 periodically acquires the right coordinates and the left coordinates of the ship 100, and controls the outboard motor 20R and the outboard motor 20L while correcting the set such that the right coordinates and the left coordinates linearly change in the moving direction included in the operation signal.

By such a second control, the ship 100 moves in parallel in the direction in which the joystick 33 is tilted.

The first determination unit 30D of the system controller 30 determines that the situation is suitable for the update processing in a case where the determination in step S3 is NO (in a case where the wave height is lower than the threshold value) (step S6).

After step S6, the first control is started by the controller 30A of the system controller 30 (step S7). When the ship 100 starts to move by this first control, the second determination unit 30E of the system controller 30 determines whether or not the set used for the first control is appropriate based on the moving state of the ship 100 (step S8).

In a case where it is determined that the setting is appropriate (step S8: YES), the first control is continued as it is. Meanwhile, in a case where it is determined that the set is not appropriate (step S8: NO), the update processing unit 30B of the system controller 30 performs the update processing of this set (step S9), and the first control is performed by the updated set.

As described above, according to the ship 100, when the joystick 33 is operated, it is determined whether or not the situation is suitable for the update processing based on the weather information at this time, and there is no case where the update processing is performed when the situation is not suitable for the update processing. Therefore, it is possible to prevent the set stored in the ROM of the storage 37 from being updated to an incorrect value.

Further, when the situation is not suitable for the update processing, the ship 100 moves in parallel according to the second control. Therefore, even when the set stored in the ROM of the storage 37 is not appropriate, the ship 100 can move accurate in parallel.

Further, according to the ship 100, whether or not the situation is suitable for the update processing is determined based on the wave height or the wind strength, and thus, this determination can be performed easily and fast. Therefore, the cost increase of the ship 100 can be prevented.

In addition, the first determination unit 30D of the system controller 30 sets the threshold value for comparison with the weather information in step S3 as a predetermined fixed value, but the threshold value may be variable. The operation of the system controller 30 in this case will be described below.

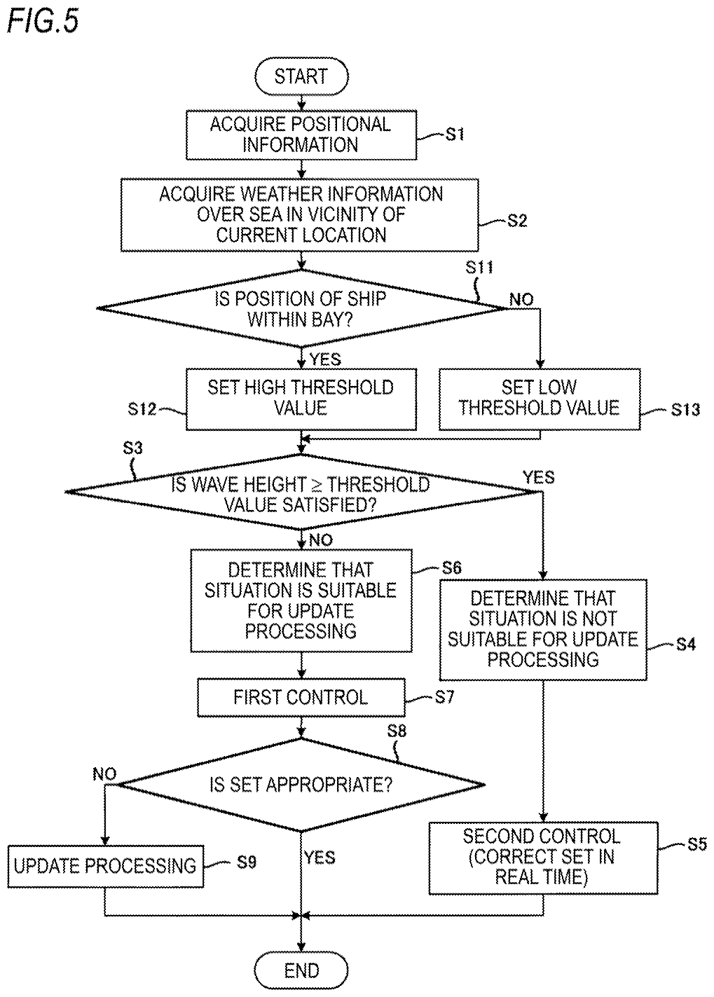

FIG. 5 is a flowchart for describing a first modification example of the operation of the system controller 30 illustrated in FIG. 2 in a case where the joystick 33 is tilted in the predetermined direction. The flowchart illustrated in FIG. 5 is the same as the flowchart illustrated in FIG. 4 except that steps S11, S12, and S13 are added. In FIG. 5, the same processing as that in FIG. 4 will be given the same reference numerals, and the description thereof will be omitted.

After step S2, the first determination unit 30D of the system controller 30 acquires positional information of the ship 100 acquired in step S1, and determines whether or not the position of the ship 100 based on this positional information is within the bay (step S11).

In a case where the position of the ship 100 is within the bay (step S11: YES), the first determination unit 30D of the system controller 30 sets a relatively high threshold value as a threshold value for comparison with the weather information (step S12).

In a case where the position of the ship 100 is outside the bay (step S11: NO), the first determination unit 30D of the system controller 30 sets a threshold value lower than the value set in step S12 as a threshold value for comparison with the weather information (step S13). After step S12 and step S13, the processing of step S3 and subsequent processing are performed.

The weather information at the position of the ship is provided as prediction information in a wide range. Therefore, in a case where the position of the ship is within the bay or outside the bay, it is considered that there is case where the wave height or the wind strength received by the ship is less than the predicted value of the weather information in a case where the ship is within the bay. Therefore, in a case where the ship is within the bay, by setting the threshold value higher than that in a case where the ship is outside the bay, it is possible to accurately determine whether or not the situation is suitable for the update processing.

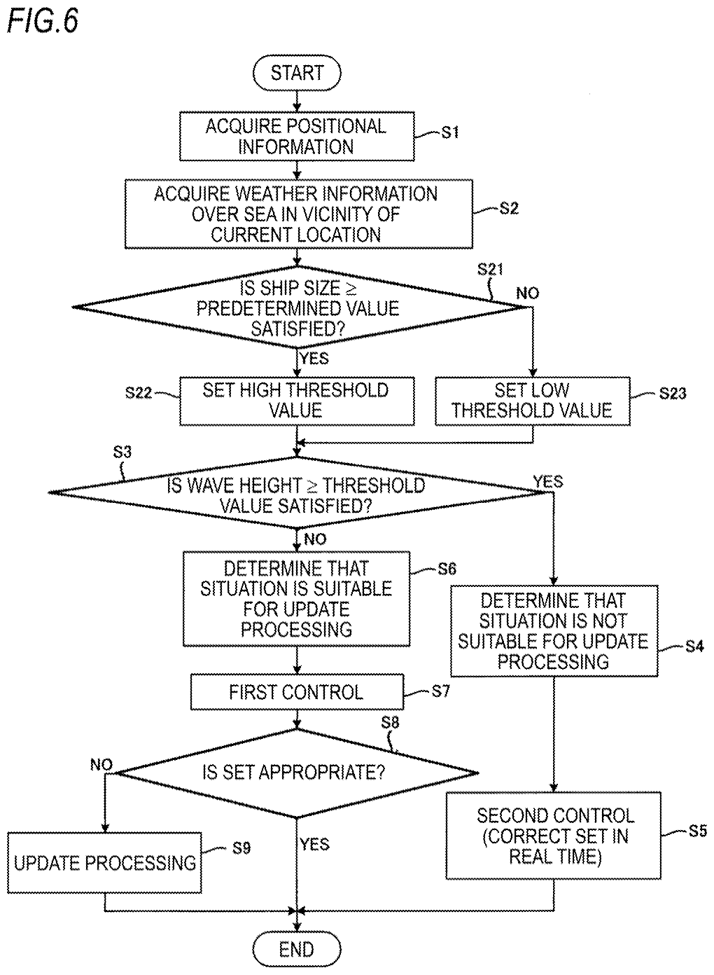

FIG. 6 is a flowchart for describing a second modification example of the operation of the system controller 30 illustrated in FIG. 2 in a case where the joystick 33 is tilted in the predetermined direction. The flowchart illustrated in FIG. 6 is the same as the flowchart illustrated in FIG. 4 except that steps S21, S22, and S23 are added. In FIG. 6, the same processing as that in FIG. 4 will be given the same reference numerals, and the description thereof will be omitted.

In the second modification example, as a premise, a plurality of values corresponding to the size of the ship 100 are stored in advance in the storage 37 as a threshold value for comparison with the weather information. In the following, it is assumed that, as the plurality of threshold values, a threshold value HT for a ship size equal to or greater than a predetermined value and a threshold value LT for a ship size less than a predetermined value are stored in the storage 37. The threshold value HT is a value greater than the threshold value LT.

In addition, in the second modification example, information on the size of the ship 100 is stored in the storage 37 when the ship 100 is manufactured.

In FIG. 6, after step S2, the first determination unit 30D of the system controller 30 acquires the information on the size of the ship 100 from the storage 37, and determines whether or not this size is equal to or greater than the predetermined value (step S21).

In a case where the size of the ship 100 is equal to or greater than the predetermined value (step S21: YES), the first determination unit 30D of the system controller 30 sets the threshold value HT corresponding to the size of the ship 100 as a threshold value for comparison with the weather information (step S22).

In a case where the size of the ship 100 is less than the predetermined value (step S21: NO), the first determination unit 30D of the system controller 30 sets the threshold value LT corresponding to the size of the ship 100 as a threshold value for comparison with the weather information (step S23). After step S22 and step S23, the processing of step S3 and subsequent processing are performed.

Even when the wave height or the wind speed are the same, in a case where the size of the ship is large and in a case where the size of the ship is small, the ship having a large size is unlikely to be affected by waves or wind. Therefore, in a case where the size of the ship is large, by setting the threshold value to be higher than that in a case where the size of the ship is small, it is possible to accurately determine whether or not the situation is suitable for the update processing.

In the ship 100 described so far, the function of the system controller 30 may be configured to be included in the ECU 21 of the outboard motor 20R or the ECU 21 of the outboard motor 20L.

In addition, in the ship 100, the joystick 33, the shift/throttle operating device 34, and the steering device 35 may be included in the outboard motor 20R or the outboard motor 20L.

Further, the ship 100 has two outboard motors 20R and 20L as propellers, but the present invention can be applied to a ship having three or more outboard motors even in a case where the ship moves in parallel by controlling the shift state of each outboard motor, the steering angle, and the propelling force.

Further, the ship 100 has a configuration including an outboard motor as a propeller, but the propeller may be an inboard motor.

Further, the propeller of the ship 100 is not limited to a case of being equipped with an internal combustion engine, and may be a case of rotating the propeller by the power of the electric motor.

Further, although the joystick 33 is used as the operation unit for performing an operation to make the ship 100 move in parallel, the present invention is not limited thereto, and for example, a plurality of buttons or the like for instructing the moving direction as the operation unit.

As described above, the following items are disclosed in the present specification.

(1) There is provided a control device of a propeller for a ship that controls the propeller in the ship equipped with a plurality of propellers, the device including: a storage that stores a set of control parameters for each of the plurality of propellers in association with an operation signal input from an operation unit to make the ship move in parallel; a controller that selectively performs a first control for controlling the plurality of propellers by the set corresponding to a first operation signal in a case where the first operation signal to make the ship move in parallel in a predetermined direction is input, and a second control for starting the control of the plurality of propellers by the set corresponding to the first operation signal, and controlling the plurality of propellers by the corrected set while correcting the set such that the ship moves in parallel based on the moving state of the ship after the control; an update processing unit that performs update processing of rewriting the set corresponding to the first operation signal stored in the storage, based on the moving state of the ship that moves according to the first control; a weather information acquisition unit that acquires weather information of the sea where the ship exists; and a first determination unit that determines whether or not the situation is suitable for the update processing based on the weather information, in which the controller performs the first control in a case where the first determination unit determines that the situation is suitable for the update processing, and performs the second control in a case where the first determination unit determines that the situation is not suitable for the update processing, in which the control device further comprises a second determination unit that determines whether or not the set corresponding to the first operation signal is appropriate, based on the moving state of the ship that moves according to the first control performed by the controller, in a case where the first determination unit determines that the situation is suitable for the update processing, and in which the update processing unit performs the update processing in a case where the second determination unit determines that the set is not appropriate.

According to this configuration, it is possible to prevent the update processing from being unnecessarily performed, and it is possible to make the ship move accurately in parallel. Further, for example, even in a case where it is determined that the set is not appropriate and the situation is not suitable for the update processing, the second control is performed, and thus, it is possible to make the ship move in parallel.

(2) In the control device of a propeller for a ship according to (1), the weather information is information indicating wave height, and the first determination unit determines that the situation is not suitable for the update processing in a case where the wave height is equal to or higher than a threshold value, and determines that the situation is suitable for the update processing in a case where the wave height is lower than the threshold value.

According to this configuration, the update processing is not performed in a situation in which the waves are high and the movement of the ship is unstable. Therefore, it is possible to prevent the set from being updated incorrectly.

(3) In the control device of a propeller for a ship according to (1), the weather information is information indicating wind strength, and the first determination unit determines that the situation is not suitable for the update processing in a case where the wind strength is equal to or greater than a threshold value, and determines that the situation is suitable for the update processing in a case where the wind strength is less than the threshold value.

According to this configuration, the update processing is not performed in a situation in which the wind is strong and the movement of the ship is unstable. Therefore, it is possible to prevent the set from being updated incorrectly.

(4) In the control device of a propeller for a ship according to (2) or (3), the first determination unit controls the threshold value.

According to this configuration, it is possible to more accurately determine whether or not the situation is suitable for the update processing.

(5) In the control device of a propeller for a ship according to (4), the first determination unit acquires information on size of the ship, and in a case where the size is a first value, the first determination unit sets the threshold value to be higher than that in a case where the size is a second value smaller than the first value.

According to this configuration, it is possible to accurately determine whether or not the situation is suitable for the update processing.

(6) In the control device of a propeller for a ship according to (4), the first determination unit acquires positional information of the ship, and in a case where the position of the ship based on the positional information is within the bay, the first determination unit sets the threshold value to be higher than that in a case where the position is outside the bay.

According to this configuration, it is possible to accurately determine whether or not the situation is suitable for the update processing.

(7) There is provided a control method of a propeller for a ship for controlling the propeller in the ship equipped with an operation unit that makes the ship having a plurality of propellers move in parallel, a storage that stores a set of control parameters for each of the plurality of propellers in association with an operation signal input from the operation unit, and the plurality of propellers, the method including: a control step of selectively performing a first control for controlling the plurality of propellers by the set corresponding to a first operation signal in a case where the first operation signal to make the ship move in parallel in a predetermined direction is input, and a second control for starting the control of the plurality of propellers by the set corresponding to the first operation signal, and controlling the plurality of propellers by the corrected set while correcting the set such that the ship moves in parallel based on the moving state of the ship after the control; an update processing step of performing update processing of rewriting the set corresponding to the first operation signal stored in the storage, based on the moving state of the ship that moves according to the first control; a weather information acquisition step of acquiring weather information of the sea where the ship exists; and a first determination step of determining whether or not the situation is suitable for the update processing based on the weather information, in which, in the control step, the first control is performed in a case where it is determined that the situation is suitable for the update processing in the first determination step, and the second control is performed in a case where it is determined that the situation is not suitable for the update processing in the first determination step, in which the control method further comprises a second determination step of determining whether or not the set corresponding to the first operation signal is appropriate, based on the moving state of the ship that moves according to the first control performed in the control step, in a case where it is determined that the situation is suitable for the update processing in the first determination step, and in which, in the update processing step, the update processing is performed in a case where it is determined that the set is not appropriate in the second determination step.

According to this method, it is possible to prevent the update processing from being unnecessarily performed, and it is possible to make the ship move accurately in parallel. Further, for example, even in a case where it is determined that the set is not appropriate and the situation is not suitable for the update processing, the second control is performed, and thus, it is possible to make the ship move in parallel.

(8) There is provided a control program of a propeller for a ship for causing a computer to execute a control method of a propeller for a ship for controlling the propeller in the ship equipped with an operation unit that makes the ship having a plurality of propellers move in parallel, a storage that stores a set of control parameters for each of the plurality of propellers in association with an operation signal input from the operation unit, and the plurality of propellers, the method including: a control step of selectively performing a first control for controlling the plurality of propellers by the set corresponding to a first operation signal in a case where the first operation signal to make the ship move in parallel in a predetermined direction is input, and a second control for starting the control of the plurality of propellers by the set corresponding to the first operation signal, and controlling the plurality of propellers by the corrected set while correcting the set such that the ship moves in parallel based on the moving state of the ship after the control; an update processing step of performing update processing of rewriting the set corresponding to the first operation signal stored in the storage, based on the moving state of the ship that moves according to the first control; a weather information acquisition step of acquiring weather information of the sea where the ship exists; and a first determination step of determining whether or not the situation is suitable for the update processing based on the weather information, in which, in the control step, the first control is performed in a case where it is determined that the situation is suitable for the update processing in the first determination step, and the second control is performed in a case where it is determined that the situation is not suitable for the update processing in the first determination step, in which the control method further comprises a second determination step of determining whether or not the set corresponding to the first operation signal is appropriate, based on the moving state of the ship that moves according to the first control performed in the control step, in a case where it is determined that the situation is suitable for the update processing in the first determination step, and in which, in the update processing step, the update processing is performed in a case where it is determined that the set is not appropriate in the second determination step.

According to this program, it is possible to prevent the update processing from being unnecessarily performed, and it is possible to make the ship move accurately in parallel. Further, for example, even in a case where it is determined that the set is not appropriate and the situation is not suitable for the update processing, the second control is performed, and thus, it is possible to make the ship move in parallel.

### INDUSTRIAL APPLICABILITY

According to the present invention, it is possible to provide a control device, a control method, and a control program of a propeller for a ship that enable the ship to make accurate parallel movement.

### REFERENCE SIGNS LIST

100: ship
10: hull
10a: stern
20R, 20L: outboard motor
21: ECU
23: throttle motor
24: steering motor
26: shift motor
27: propeller
30: system controller
30A: controller
30B: update processing unit
30C: weather information acquisition unit
30D: first determination unit
30E: second determination unit
31: orientation sensor
32R, 32L: receiver
33: joystick
34: shift/throttle operating device
35: steering device
36: communication interface
37: storage

1. A control device of a propeller for a ship configured to control the propeller in the ship equipped with a plurality of propellers, the device comprising:
a storage configured to store a set of control parameters for each of the plurality of propellers in association with an operation signal input from an operation unit to make the ship move in parallel;
a controller configured to selectively perform a first control for controlling the plurality of propellers by the set corresponding to a first operation signal in a case where the first operation signal to make the ship move in parallel in a predetermined direction is input, and a second control for starting the control of the plurality of propellers by the set corresponding to the first operation signal, and controlling the plurality of propellers by the corrected set while correcting the set so that the ship moves in parallel based on the moving state of the ship after the control;
an update processing unit configured to perform update processing of rewriting the set corresponding to the first operation signal stored in the storage, based on the moving state of the ship that moves according to the first control;
a weather information acquisition unit configured to acquire weather information of the sea where the ship exists;
a first determination unit configured to determine whether or not the situation is suitable for the update processing based on the weather information; and
a second determination configured to determine whether or not the set corresponding to the first operation signal is appropriate, based on the moving state of the ship that moves according to the first control performed by the controller, in a case where the first determination unit determines that the situation is suitable for the update processing,
wherein the controller performs the first control in a case where the first determination unit determines that the situation is suitable for the update processing, and performs the second control in a case where the first determination unit determines that the situation is not suitable for the update processing, and
wherein the update processing unit performs the update processing in a case where the second determination unit determines that the set is not appropriate.

2. The control device of a propeller for a ship according to claim 1,
wherein the weather information is information indicating wave height, and
the first determination unit determines that the situation is not suitable for the update processing in a case where the wave height is equal to or higher than a threshold value, and determines that the situation is suitable for the update processing in a case where the wave height is lower than the threshold value.

3. The control device of a propeller for a ship according to claim 1,
wherein the weather information is information indicating wind strength, and
the first determination unit determines that the situation is not suitable for the update processing in a case where the wind strength is equal to or greater than a threshold value, and determines that the situation is suitable for the update processing in a case where the wind strength is less than the threshold value.

4. The control device of a propeller for a ship according to claim 2,
wherein the first determination unit controls the threshold value.

5. The control device of a propeller for a ship according to claim 4,
wherein the first determination unit acquires information on size of the ship, and in a case where the size is a first value, the first determination unit sets the threshold value to be higher than that in a case where the size is a second value smaller than the first value.

6. The control device of a propeller for a ship according to claim 4,
wherein the first determination unit acquires positional information of the ship, and in a case where the position of the ship based on the positional information is within the bay, the first determination unit sets the threshold value to be higher than that in a case where the position is outside the bay.

7. A control method of a propeller for a ship for controlling the propeller in the ship equipped with an operation unit that makes the ship having a plurality of propellers move in parallel, a storage that stores a set of control parameters for each of the plurality of propellers in association with an operation signal input from the operation unit, and the plurality of propellers, the method comprising:
a control step of selectively performing a first control for controlling the plurality of propellers by the set corresponding to a first operation signal in a case where the first operation signal to make the ship move in parallel in a predetermined direction is input, and a second control for starting the control of the plurality of propellers by the set corresponding to the first operation signal, and controlling the plurality of propellers by the corrected set while correcting the set so that the ship moves in parallel based on the moving state of the ship after the control;
an update processing step of performing update processing of rewriting the set corresponding to the first operation signal stored in the storage, based on the moving state of the ship that moves according to the first control;
a weather information acquisition step of acquiring weather information of the sea where the ship exists; and
a first determination step of determining whether or not the situation is suitable for the update processing based on the weather information,
wherein, in the control step, the first control is performed in a case where it is determined that the situation is suitable for the update processing in the first determination step, and the second control is performed in a case where it is determined that the situation is not suitable for the update processing in the first determination step,
wherein the control method further comprises a second determination step of determining whether or not the set corresponding to the first operation signal is appropriate, based on the moving state of the ship that moves according to the first control performed in the control step, in a case where it is determined that the situation is suitable for the update processing in the first determination step, and
wherein, in the update processing step, the update processing is performed in a case where it is determined that the set is not appropriate in the second determination step.

8. A non-transitory computer-readable storage medium storing a control program of a propeller for a ship for causing a computer to execute a control method of a propeller for a ship for controlling the propeller in the ship equipped with an operation unit that makes the ship having a plurality of propellers move in parallel, a storage that stores a set of control parameters for each of the plurality of propellers in association with an operation signal input from the operation unit, and the plurality of propellers, the method comprising:
a control step of selectively performing a first control for controlling the plurality of propellers by the set corresponding to a first operation signal in a case where the first operation signal to make the ship move in parallel in a predetermined direction is input, and a second control for starting the control of the plurality of propellers by the set corresponding to the first operation signal, and controlling the plurality of propellers by the corrected set while correcting the set so that the ship moves in parallel based on the moving state of the ship after the control;
an update processing step of performing update processing of rewriting the set corresponding to the first operation signal stored in the storage, based on the moving state of the ship that moves according to the first control;
a weather information acquisition step of acquiring weather information of the sea where the ship exists; and
a first determination step of determining whether or not the situation is suitable for the update processing based on the weather information,
wherein, in the control step, the first control is performed in a case where it is determined that the situation is suitable for the update processing in the first determination step, and the second control is performed in a case where it is determined that the situation is not suitable for the update processing in the first determination step,
wherein the control method further comprises a second determination step of determining whether or not the set corresponding to the first operation signal is appropriate, based on the moving state of the ship that moves according to the first control performed in the control step, in a case where it is determined that the situation is suitable for the update processing in the first determination step, and
wherein, in the update processing step, the update processing is performed in a case where it is determined that the set is not appropriate in the second determination step.

9. The control device of a propeller for a ship according to claim 3,
wherein the first determination unit controls the threshold value.

10. The control device of a propeller for a ship according to claim 9,
wherein the first determination unit acquires information on size of the ship, and in a case where the size is a first value, the first determination unit sets the threshold value to be higher than that in a case where the size is a second value smaller than the first value.

11. The control device of a propeller for a ship according to claim 9,
wherein the first determination unit acquires positional information of the ship, and in a case where the position of the ship based on the positional information is within the bay, the first determination unit sets the threshold value to be higher than that in a case where the position is outside the bay.
